(19) United States
(12) Patent Application Publication
(10) Pub. No.: US 2019/0388977 A1
(43) Pub. Date: Dec. 26, 2019

(54) HARD TURNING SYSTEMS AND METHODS

(71) Applicant: Hamilton Sundstrand Corporation, Charlotte, NC (US)

(72) Inventors: Andy Mugrage, Byron, IL (US); Shawn Karl Reynolds, Byron, IL (US)

(21) Appl. No.: 16/017,462

(22) Filed: Jun. 25, 2018

(51) Int. Cl. B23B 29/12

(52) U.S. Cl. CPC B23B 29/125; B23Q 1/25

(57) ABSTRACT

A method can include vibrating a hard turning tool, and contacting the hard turning tool to a spinning work piece while vibrating the hard turning tool to remove material from the spinning work piece. The method can further include moving the tool in an axial direction and/or radial direction relative to the work piece.

### BACKGROUND

### 1. Field

The present disclosure relates to hard turning, more specifically to systems and methods for hard turning.

### 2. Description of Related Art

Finish machining of cylindrical features on shaft-type components can be required to meet many specifications. Hard turning is a process that allows for improved productivity compared to other processes (e.g., grinding). However, the traditional hard turning process results in a spiral lead around the feature. This spiral lead can become a leak path for lubricants, for example, in sealed shaft applications.

Such conventional methods and systems have generally been considered satisfactory for their intended purpose. However, there is still a need in the art for improved hard turning systems and processes. The present disclosure provides a solution for this need.

### SUMMARY

A method can include vibrating a hard turning tool, and contacting the hard turning tool to a spinning work piece while vibrating the hard turning tool to remove material from the spinning work piece. The method can further include moving the tool in an axial direction and/or radial direction relative to the work piece.

Vibrating the hard turning tool can include vibrating the hard turning tool in a radial direction relative to the work piece. In certain embodiments, vibrating the hard turning tool includes vibrating the hard turning tool in an axial direction relative to the work piece. Vibrating the hard turning tool can include vibrating the hard turning tool in a tangential direction relative to the work piece. In certain embodiments, vibrating the hard turning tool includes vibrating the hard turning tool in at least two of an axial direction, radial direction, and/or a tangential direction relative to the work piece.

Vibrating the hard turning tool can include vibrating at a vibratory frequency configured to remove or prevent formation of a spiral line on the outer surface of the work piece. The method can include forming a smooth shaft. In certain embodiments, the vibratory frequency can be an ultrasonic frequency. Any other suitable frequency to provide any suitable result (e.g., smoothness) is contemplated herein.

In accordance with at least one aspect of this disclosure, a method can include vibrating a hard turning tool during a hard turning process to smooth a work piece subjected to the hard turning process. The method can include any other suitable portions of a method disclosed herein.

In accordance with at least one aspect of this disclosure, a hard turning system can include a hard turning tool configured to contact a spinning work piece and remove material therefrom. The system can also include a vibration generator operatively connected to the hard turning tool and configured to vibrate the hard turning tool while the hard turning tool is contacting the spinning work piece.

The vibration generator can be configured to vibrate the hard turning tool in a radial direction relative to the work piece. In certain embodiments, the vibration generator can be configured to vibrate the hard turning tool in an axial direction relative to the work piece. The vibration generator can be configured to vibrate the hard turning tool in a tangential direction relative to the work piece. In certain embodiments, the vibration generator can be configured to vibrate the hard turning tool in at least two of an axial direction, radial direction, and/or a tangential direction relative to the work piece.

The hard turning tool can include a contact head. The vibration generator can be connected to the contact head. The vibration generator can be connected to any other suitable portion of the hard turning tool to pass vibrations to the contact head.

The hard turning tool can be connected to a machine configured to move the contact head in at least one direction relative to the work piece. The at least one direction can include at least one of a radial direction, an axial direction, and a tangential direction.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an embodiment of a system in accordance with this disclosure, showing an embodiment of a hard turning tool vibrating in at least one direction while contacting a spinning work piece during a hard turning process.

### DETAILED DESCRIPTION

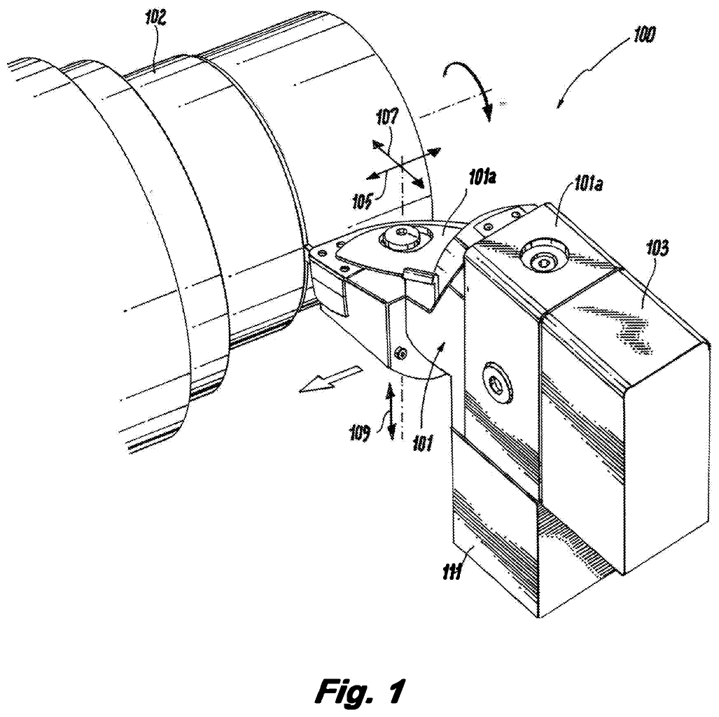

Reference will now be made to the drawings wherein like reference numerals identify similar structural features or aspects of the subject disclosure. For purposes of explanation and illustration, and not limitation, an illustrative view of an embodiment of a system in accordance with the disclosure is shown in FIG. 1 and is designated generally by reference character 100. The systems and methods described herein can be used to improve the hard turning process.

Referring to FIG. 1, in accordance with at least one aspect of this disclosure, a hard turning system 100 can include a hard turning tool 101 configured to contact a spinning work piece 102 and remove material therefrom. The hard turning tool 101 can include any suitable configuration and/or components as appreciated by those having ordinary skill in the art of hard turning (e.g., a tip harder than the work piece).

The system 100 can also include a vibration generator 103 operatively connected to the hard turning tool 101 and configured to vibrate the hard turning tool 101 (e.g., a contact head 101a thereof) while the hard turning tool 101 is contacting the spinning work piece 102. The vibration generator 103 can be configured to vibrate the hard turning tool 101 in a radial direction 107 (e.g., into and/out of the work piece 102) relative to the work piece 102. In certain embodiments, the vibration generator can be configured to vibrate the hard turning tool 101 in an axial direction 105 (e.g., a direction of translation motion of the tool 101) relative to the work piece 102. The vibration generator 103 can be configured to vibrate the hard turning tool 109 in a tangential direction (e.g., tangential to the surface of a shaft) relative to the work piece 102.

In certain embodiments, the vibration generator 103 can be configured to vibrate the hard turning tool 101 in at least two of an axial direction 105, radial direction 107, and/or a tangential direction 109 relative to the work piece 102. Any other suitable direction and/or number of directions are contemplated herein.

As shown, the hard turning tool 101 can include a contact head 101a. The vibration generator 103 can be connected to the contact head 101a, e.g., to directly provide vibratory force thereto. The vibration generator 103 can be connected to any other suitable portion of the hard turning tool 101 to pass vibrations to the contact head 101a.

The vibration generator 103 can be configured to vibrate the tool 101 at a vibratory frequency (and/or amplitude) that is configured to remove or prevent formation of a spiral lead line on the outer surface of the work piece 102, e.g., to form a smooth shaft. In certain embodiments, the vibratory frequency can be an ultrasonic frequency and the vibration generator 103 can include an ultrasonic (e.g., high-frequency, low-amplitude) vibration generator. Any other suitable frequency to provide any suitable result (e.g., for smoothness, to match translation speed of cutting in the axial and/or radial direction, to avoid harmonics, etc.).

In certain embodiments, the vibration generator can be a variable frequency generator to provide a variable vibration frequency, e.g., which can change during operation as a function of smoothness for example, or for any other reason. The vibration generator can include any suitable vibration generating device(s) as appreciated by those having ordinary skill in the art in view of this disclosure.

The hard turning tool 101 can be connected to a machine 111 (e.g., a CNC type machine or any other suitable positioning machine) configured to move the contact head in at least one direction relative to the work piece 102. The at least one direction can include at least one of a radial direction 107, an axial direction 105, and a tangential direction 109. The machine 111 can include any suitable controller (e.g., having any suitable hardware and/or software module(s)) configured to execute one or more methods in accordance with this disclosure.

In accordance with at least one aspect of this disclosure, a method can include vibrating a hard turning tool 101, and contacting the hard turning tool 101 (e.g., a head 101a thereof) to a spinning work piece 102 while vibrating the hard turning tool 101 to remove material from the spinning work piece 102. The method can further include moving the tool 101 in an axial direction 105 and/or radial direction 107 relative to the work piece 102, as shown.

Vibrating the hard turning tool 101 can include vibrating the hard turning tool 101 in a radial direction 107 relative to the work piece 102. In certain embodiments, vibrating the hard turning tool 101 includes vibrating the hard turning tool 101 in an axial direction 105 relative to the work piece 102. Vibrating the hard turning tool 101 can include vibrating the hard turning tool 101 in a tangential direction 109 relative to the work piece 102. In certain embodiments, vibrating the hard turning tool 101 includes vibrating the hard turning tool 101 in at least two of an axial direction 105, radial direction 107, and/or a tangential direction 109 relative to the work piece 102. The tool 101 can be vibrated in any other suitable direction or number of directions.

Vibrating the hard turning tool 101 can include vibrating at a vibratory frequency that is configured to remove or prevent formation of a spiral line on the outer surface of the work piece 102. For example, the method can include forming a smooth shaft, e.g. as shown. In certain embodiments, the vibratory frequency can be an ultrasonic frequency. Any other suitable frequency to provide any suitable result (e.g., smoothness) is contemplated herein.

In accordance with at least one aspect of this disclosure, a method can include vibrating a hard turning tool 101 during a hard turning process to smooth a work piece 102 subjected to the hard turning process (e.g., to remove a spiral lead line formed in process). A method can include removing a spiral lead line formed in hard turning process by vibrating the hard turning tool 101. Any method disclosed herein can include any other suitable method or portion(s) thereof as appreciate by one having ordinary skill in the art in view of this disclosure.

As will be appreciated by those skilled in the art, aspects of the present disclosure may be embodied as a system, method or computer program product. Accordingly, aspects of this disclosure may take the form of an entirely hardware embodiment, an entirely software embodiment (including firmware, resident software, micro-code, etc.), or an embodiment combining software and hardware aspects, all possibilities of which can be referred to herein as a “circuit,” “module,” or “system.” A “circuit,” “module,” or “system” can include one or more portions of one or more separate physical hardware and/or software components that can together perform the disclosed function of the “circuit,” “module,” or “system”, or a “circuit,” “module,” or “system” can be a single self-contained unit (e.g., of hardware and/or software). Furthermore, aspects of this disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of this disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the this disclosure may be described above with reference to flowchart illustrations and/or block diagrams of methods, apparatus (systems) and computer program products according to embodiments of this disclosure. It will be understood that each block of any flowchart illustrations and/or block diagrams, and combinations of blocks in any flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in any flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified herein.

As appreciated by those having ordinary skill in the art, hard turning is an alternative to grinding which can be used to achieve a very precise geometry, e.g., of a shaft. Embodiments can remove and/or prevent the formation of spiral lead line created in traditional hard turning processes. Embodiments can microscopically break up the feed spiral produced from the hard turning processes. By using vibration (e.g., an ultrasonic high-frequency, low-amplitude vibration generator) with the hard turning cutting tool can produce an improved surface topology and can eliminate leak path risk in seal shaft applications. Embodiments allow the use of hard turning on many features thereby increasing productivity and reducing piece part cost.

Any suitable combination(s) of any disclosed embodiments and/or any suitable portion(s) thereof are contemplated herein as appreciated by those having ordinary skill in the art.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

1. A method, comprising:
vibrating a hard turning tool; and
contacting the hard turning tool to a spinning work piece while vibrating the hard turning tool to remove material from the spinning work piece.

2. The method of claim 1, further comprising moving the tool in an axial direction and/or radial direction relative to the work piece.

3. The method of claim 1, wherein vibrating the hard turning tool includes vibrating the hard turning tool in a radial direction relative to the work piece.

4. The method of claim 1, wherein vibrating the hard turning tool includes vibrating the hard turning tool in an axial direction relative to the work piece.

5. The method of claim 1, wherein vibrating the hard turning tool includes vibrating the hard turning tool in a tangential direction relative to the work piece.

6. The method of claim 1, wherein vibrating the hard turning tool includes vibrating the hard turning tool in at least two of an axial direction, radial direction, and/or a tangential direction relative to the work piece.

7. The method of claim 1, wherein vibrating the hard turning tool includes a vibratory frequency configured to remove or prevent formation of a spiral line on the outer surface of the work piece.

8. The method of claim 7, wherein the vibratory frequency is an ultrasonic frequency.

9. The method of claim 1, further comprising forming a smooth shaft.

10. A method, comprising;
vibrating a hard turning tool during a hard turning process to smooth a work piece subjected to the hard turning process.

11. A hard turning system, comprising:
a hard turning tool configured to contact a spinning work piece and remove material therefrom; and
a vibration generator operatively connected to the hard turning tool and configured to vibrate the hard turning tool while the hard turning tool is contacting the spinning work piece.

12. The system of claim 11, wherein the vibration generator is configured to vibrate the hard turning tool in a radial direction relative to the work piece.

13. The system of claim 11, wherein the vibration generator is configured to vibrate the hard turning tool in an axial direction relative to the work piece.

14. The system of claim 11, wherein the vibration generator is configured to vibrate the hard turning tool in a tangential direction relative to the work piece.

15. The system of claim 11, wherein the vibration generator is configured to vibrate the hard turning tool in at least two of an axial direction, radial direction, and/or a tangential direction relative to the work piece.

16. The system of claim 11, wherein the hard turning tool includes a contact head, wherein the vibration generator is connected to the contact head.

17. The system of claim 16, wherein the hard turning tool is connected to a machine configured to move the contact head in at least one direction relative to the work piece.

18. The system of claim 17, wherein the at least one direction includes at least one of a radial direction, an axial direction, and a tangential direction.
